(19) United States
(12) Patent Application Publication
(10) Pub. No.: US 2019/0087531 A1
(43) Pub. Date: Mar. 21, 2019

(54) SYSTEMS, DEVICES, AND METHODS FOR A MODULAR PASSENGER AIRCRAFT CABIN AND DESIGN THEREOF

(71) Applicant: AIRBUS GROUP HQ INC DBA A3 BY AIRBUS GROUP, San Jose, CA (US)

(72) Inventor: Jason Chua, San Jose, CA (US)

(21) Appl. No.: 16/192,336

(22) Filed: Nov. 15, 2018

Related U.S. Application Data
(63) Continuation of application No. PCT/US17/33181, filed on May 17, 2017.
(60) Provisional application No. 62/338,214, filed on May 18, 2016.

(51) Int. Cl. G06F 17/50; B64D 11/06

(52) U.S. Cl. CPC G06F 17/5095; B64D 2011/0046; B64D 11/0602; B64D 11/0601

(57) ABSTRACT

Systems, devices, and methods are provided that relate to aircraft with modular cabins and modular distributions. The aircraft may include a set of modules and a centralized utility bus. A module creation ecosystem may be provided that provides module designers with information about module dimensions, utilities and design rules. Considerations for designing, certifying, selecting, distributing, building, and installing modules in or for an aircraft are set forth.

### FIELD

The subject matter described herein relates to systems, devices, and methods related to a modular passenger aircraft.

### BACKGROUND

Passenger aircraft traditionally have a relatively fixed cabin design and infrastructure. From early aircraft with rows of wicker chairs to modern interiors where the chairs and seats include features such as entertainment consoles and wicker seats, interior aircraft design has largely focused on providing an appropriate number of seats and configuration within a particular aircraft platform, along with necessary features such as bathrooms and storage for cabin service items. Although some large aircraft may include additional features such as lay flat seats, private cabins, and lounge areas, aircraft cabins generally include a limited number of seating and non-seating options.

Traditional aircraft cabins also suffer from a lack of flexibility for cabin configurations. Implementing an interior design is very expensive and semi-permanent. Aircraft interiors typically have a 10+ year lifespan. If customer demand changes or new features become available, an interior quickly becomes obsolete or undesirable. Because it is extremely expensive to upgrade or update the cabin, these undesirable interiors may persist within a fleet for years. Moreover, as a result of the expense and difficulty in updating interiors, an industry may trend towards risk-averse interior designs with known return on investment, and may be missing out on opportunities to significantly improve customer experiences and carrier profitability. Thus, an entire industry of carriers may trend towards similar designs that vary little from early designs.

A carrier may end up with a fleet that has a variety of different cabin configurations based on different specific cabin designs that were prevalent when particular aircraft were purchased or updated. As a result, different planes may provide differing levels of customer experience. Some carriers may assign certain aircraft to a particular subset of routes based on factors such as customer demand for different amenities such as first class seats, entertainment, or other premium services. Short term changes in demand for certain services (e.g., as a result of large events, etc.) may require careful rebalancing throughout an entire fleet, as access to certain services may be limited. In some instances, carriers may lose significant revenue based on the available aircraft at an airport location not matching the types of seating and services that are desired by customers on a particular day.

Because of the limited number of configurations that are actually used in aircraft and regulatory requirements for the certification of aircraft interiors, a limited number of specialized interior suppliers may design and supply a large percentage of interiors for passenger aircraft. The current supply chain and regulatory framework may require large capital expenditures that effectively limit the ability of existing and new interior suppliers to create innovative interiors that may suit specialized customer needs.

### SUMMARY

Systems, devices, and methods are provided that relate to aircraft with modular cabins and modular distributions. The aircraft may include a set of modules and a centralized utility bus. A module creation ecosystem may be provided that provides module designers with information about module dimensions, utilities and design rules. Considerations for designing, certifying, selecting, distributing, building, and installing modules in or for an aircraft are set forth. The specific embodiments disclosed herein and the systems, components, methods, modules, aircraft, etc. described herein need not take the specific form described, but may instead be applied in various different or additional manners consistent with the present disclosure and claims. The disclosed subject matter is not limited to any single or specific embodiment described herein, but rather should be construed in breadth and scope in accordance with the appended claims.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 shows an illustrative aircraft with a modular cabin and module distribution in accordance with some embodiments of the present disclosure;

FIG. 2 shows a plurality of illustrative modules in accordance with some embodiments of the present disclosure;

FIG. 3 shows an illustrative modular cabin design and certification system in accordance with some embodiments of the present disclosure;

FIG. 4 depicts a non-limiting flow diagram illustrating exemplary methods for designing and certifying a modular cabin configuration in accordance with some embodiments of the present disclosure;

FIG. 5 shows an illustrative module distribution system of an airport in accordance with some embodiments of the present disclosure;

FIG. 6 shows an illustrative module selection system in accordance with some embodiments of the present disclosure;

FIG. 7 depicts a non-limiting flow diagram illustrating exemplary methods for designing an aircraft and module configuration in accordance with some embodiments of the present disclosure; and

FIG. 8 depicts a non-limiting flow diagram illustrating exemplary methods for assembling a modular cabin of an aircraft in accordance with some embodiments of the present disclosure.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

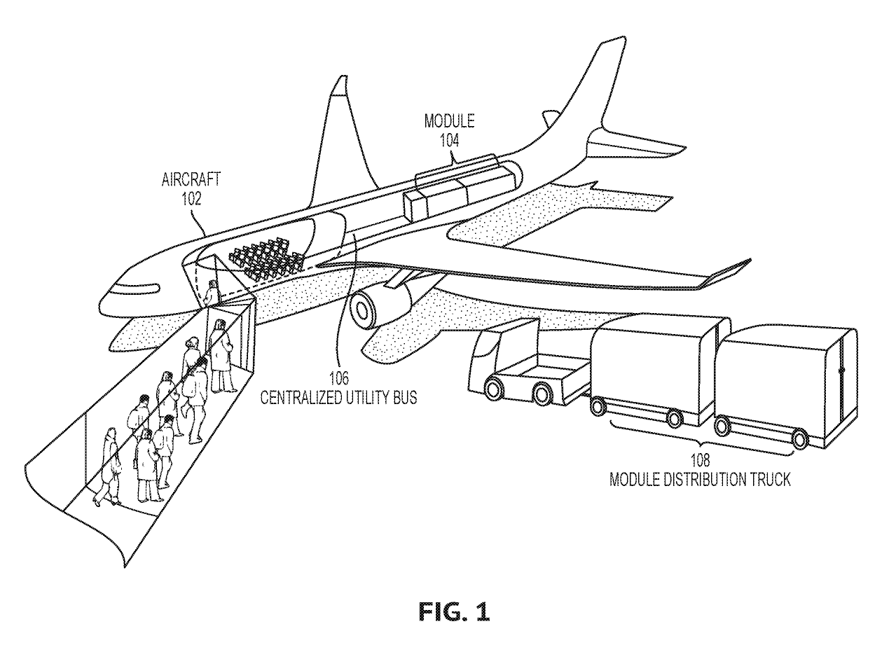

FIG. 1 shows an illustrative aircraft 102 with a modular cabin and module distribution in accordance with some embodiments of the present disclosure. As is depicted in FIG. 1, an exemplary aircraft 102 may include a set of modules 104 and a centralized utility bus 106. Although a particular aircraft 102 is depicted in FIG. 1, it will be understood that any suitable aircraft type (e.g., multi-level aircraft, etc.) may utilize the modular cabin and systems described herein. The exemplary aircraft 102 of FIG. 1 may be located on an airport tarmac during a passenger and module loading and unloading phase.

As is depicted in FIG. 1, at least a portion of the aircraft cabin may include a modular cabin setup, in which modules may be quickly inserted and removed into at least a portion of the cabin. In the embodiment depicted in FIG. 1, the entire cabin portion of the aircraft may utilize modules. Each module may be a separate unit that includes different available features as described herein (e.g., personalized cabins, first class seating, business class seating, economy seating, lounge, sleeping room, wellness center, workout room, theater room, sports viewing room, bathroom facilities, office galley, etc.). As is depicted in FIG. 1, a first two modules from the front of the aircraft (depicted in a partial section view of the aircraft) may include conventional seating for passengers. Additional modules 104 (depicted in perspective view, the exterior of aircraft 102 depicted as a partial section view) may already be inserted in aircraft 104 and additional modules 104 may be in the process of being transported to be inserted into the cabin of aircraft 102 by module distribution truck 108.

In addition to a passenger loading door, aircraft 102 may also include a module door (not specifically depicted in FIG. 1) having dimensions that allows the modules 104 to be easily inserted and removed from aircraft 102 (e.g., using cargo loading and unloading infrastructure to transport modules to an aircraft 102 and place them in the aircraft 102). Aircraft 102 may also include internal structures that facilitate the movement and positioning of the modules 104 within the aircraft. In some embodiments, rollers, tracks, pulleys, drive systems, hooks, and similar devices may be used to allow the modules 104 to be placed at a particular position within the aircraft 102 once inserted through the cargo door. In some embodiments, the positioning within the aircraft may be automated, for example, based on positioning information provided to a computing system of aircraft 102 and/or a module 104. Once each module 104 is positioned within the aircraft 102, it may be locked in at a plurality of locations (e.g., using hooks, straps, magnetic forces, gearing mechanisms, etc.). In some embodiments, doors may be opened and/or walls retracted or removed along the length of the aircraft such that the modular interior may appear to an ordinary observer as similar to a conventional cabin with seams. Portions of the module 104 walls that are adjacent to the aircraft exterior may partially retract in a manner that allows unfettered access to aircraft features such as windows and emergency exit doors as desired.

Modules 104 that are loaded into aircraft 102 may be supplied with various services and utilities based on module features and needs. Although these services and utilities may be routed to the modules in a variety of ways, in an embodiment at least a portion of the utilities may be routed along a centralized utility bus 106 of the aircraft. The centralized utility bus 106 may include a plurality of fixed and/or movable connection points that may mate with corresponding connection devices of the modules 104. Example connection point devices may include quick connection technologies such as magnetic connectors or servo-controlled connections points that automatically mate in response to a corresponding connection point. In some embodiments, configurations may be pre-designed such that the connection points of the centralized utility bus 106 may automatically connect with the corresponding connection points of the modules 104. For example, a configuration may be programmed into a computing system of the aircraft 102 and/or modules 104 that defines the types of modules 104, the location of the modules within the aircraft 102, and the types of utilities needed by each module 104, the relative locations of connection points, any other suitable information relating to utilities, or any suitable combination thereof. The connections between the centralized utility bus 106 and the modules 106 may be completed based on this configuration.

Exemplary utilities that may be provided by a centralized utility bus 106 may include air, water, waste, electricity, data, oxygen, etc. It will, however, be appreciated that other services and utilities may also be convenient and could readily be added to aircraft 102 using the centralized utility bus 106. In an embodiment, some utilities may be independently generated or provided within modules 102 (e.g., waste may be stored and oxygen may be generated at a module 104) while other utilities (e.g., electricity, data, and water) may be provided by the centralized utility bus 106. In some embodiments, certain zones of the aircraft may have certain utilities that typically do not need to be provided to the entire cabin, such as waste and water. Zones may be provided that include these utilities so that they do not need to be provided in the modules or on the common utility bus 106. In this manner, certain modules 104 (e.g., a restroom module, galley, or shower) may be limited to certain zones within an aircraft that are compatible with the modules 104.

It will also be appreciated that each module 104 may likely have certain self-contained safety or emergency features such as fire extinguishers, sprinklers, air locks, floatation devices, and/or parachutes. The modular cabin configuration further allows greater flexibility in emergency situations, increasing the likelihood of positive outcomes.

Once the modules 104 are inserted into the aircraft, locked in to locations within the aircraft, connected to utilities, connected to each other, and opened to provide access to hallways, windows, and exits, the modular configuration of the aircraft 102 may be complete. During aircraft operations, some or all of the modules may be swapped after passengers unload from the aircraft. Previously cleaned, stocked, and configured modules may be provided for the aircraft, obviating some or all of the need to individually clean and restock an aircraft in a high-cost environment (e.g., at the airport gate). Modules may be returned to a centralized facility where cleaning and restocking may be performed by specialized personal in an environment that is conducive to cost-effective servicing (e.g., at a warehouse facility with customized cleaning equipment, devices, and personnel). Distribution centers may coordinate with flight control to efficiently deliver modules to aircraft gates as planes arrive, facilitate a quick and efficient turnaround of aircraft. In some embodiments, rather than removing an aircraft from service temporarily to deal with cabin problems (e.g., broken seats, equipment, electrical systems, or lavatories), problem portions of a cabin may be replaced. In some embodiments as described herein, only certain services may be swapped out (e.g., a lounge module used during an early evening flight may be replaced with a sleeping module for an overnight flight).

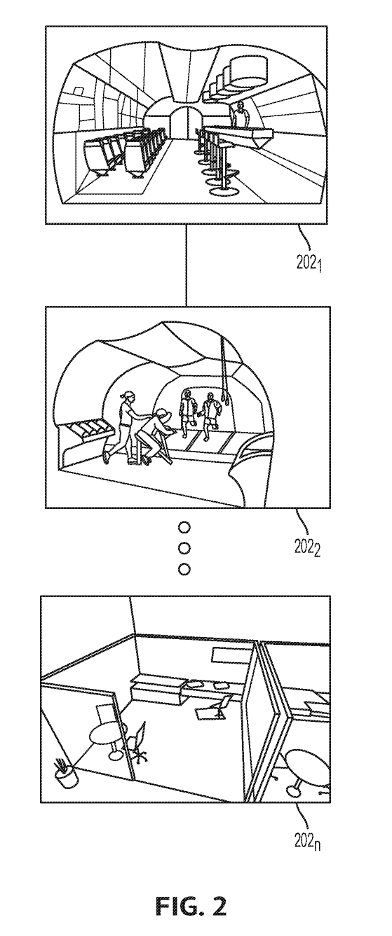

FIG. 2 shows a plurality of illustrative modules 202₁-202ₙ in accordance with some embodiments of the present disclosure. As described herein, module types may be limited only by factors such as available space, utilities, and regulatory requirements. A module creation ecosystem may be provided that provides module designers with information about module dimensions, utilities and design rules. Each module has dimensions defined by an enclosure, which defines an interior volume and interior and exterior surfaces. Module designers and suppliers may create modules that include module features are useful for many suitable purpose, such as conventional differentiated seating modules (e.g., first class, business class, premium economy class, economy class etc.), office modules (e.g., similar to small cubicles with workspace, chairs, monitors, high speed connections, etc.), meeting and business modules (e.g., chairs, desks and/or a conference space for a group of traveling coworkers or for meetings), family modules (e.g., for families traveling together, with small children, etc.), lounge or party modules (e.g., for all passengers, some passengers, or a group), wellness and exercise modules (e.g., for massage, weights, exercise equipment etc.), shower modules, sleeping modules, beauty modules (e.g., for makeup, hair care, etc.), gaming modules (e.g., having immersive or gaming experiences), or any other suitable module that may be designed to meet a customer need.

Customer access to different modules may be managed in a variety of ways. For example, customers may purchase access to a particular module prior to a flight, or in some embodiments, during flight. Passengers may be purchase blocks of time within modules, such that some passengers may cycle through the aircraft to different modules during flight. In this manner, even long flights may provide a superior and more comfortable customer experience to conventional customers who might spend a portion of the flight in an economy seat but spend other parts of the flight circulating to one or two custom modules. In an embodiment, pricing for module usage could be dynamically adjusted before or during flight based on customer demand, thus balancing usage of the modules during flight.

An exemplary lounge and dining module 202₁ is depicted in FIG. 2. Lounge and dining module 202₁ includes seating at tables and at a counter. Lounge and dining module 202₁ may be connected to centralized utility bus 106 and may receive and/or produce utilities such as water, waste, electricity, air, ventilation, data, or other. A dining module such as the one shown in FIG. 2 could be operable to replace customary meal and/or food service on aircraft, or could supplement more traditional food service offerings.

An exemplary spa and fitness module 202₂ includes features for exercise such as treadmills, stationary bikes, or other fitness equipment. The module 202₂ may also be equipped with massage chairs, or facilities for other treatments such as nail, hair, or face treatments. In one embodiment, fitness module 202₁ is equipped with locker and shower facilities, while in other embodiments such services may be provided at a separate module.

An exemplary office/workspace module 202ₙ includes equipment for office usage such as a computer, printer, photocopier, and other accessories. Each of these components may be physically attached and customized in order to prevent unwanted movements during flight. A plurality of work cubes or pods may be provided with soundproofing, higher speed connections, telepresence equipment, and other similar workplace equipment to facilitate the efficient use of the workspace.

Facilitating a module-based cabin interior system in this manner may provide advantages to aircraft manufactures and purchasers, who may be able to separate industrial design of the aircraft platform from design of an aircraft interior. Once a design is complete and a customer has placed an order, the aircraft may require little customization, since the principle mode of customization may be performed with modules, the purchase of which may be performed separately from the aircraft. Even if an aircraft is to be provided with a core set of modules that will likely remain in the aircraft during most flights (e.g., conventional seating modules, a galley module, and a head module), the modules may be constructed in parallel with the aircraft and “final assembly” will simply require inserting the modules in to the aircraft. In this manner, the lead time for building passenger aircraft may be significantly reduced. An ecosystem for module developers may allow for increased testing and acceptance of new interior designs, which may be updated on a frequent and even per-flight basis.

In an embodiment, each module 104 may include a module operations control device (not depicted), which may include a computing device including a processor and memory. The module operations control device may be configured with varying complexity based on the particular setup of the module, and in some embodiments may include a plurality of module operations control devices. For example, a module control device may include a processor, memory, and a communication device (e.g., for communicating wirelessly and/or via the data bus) that allows the module 104 to communicate with the aircraft. Communications with an aircraft may include information for setting up the module during installation within the aircraft (e.g., required utilities, position within an aircraft, location of utility interfaces, etc.), information about the particular module (e.g., about available food and drink options, stocks of spa supplies, available movies, etc.), and data from the module (e.g., data about usage of resources within the module, module traffic, purchases made within in the module, customer information, information from sensors relating to customer usage, traffic within a module, etc.). In an embodiment, data from the module may be used along with other information (e.g., time, route, frequent flier, and similar information) to perform analytics that may be used to assist for customer identification and targeting, module design, menus of services provided by a module, etc.

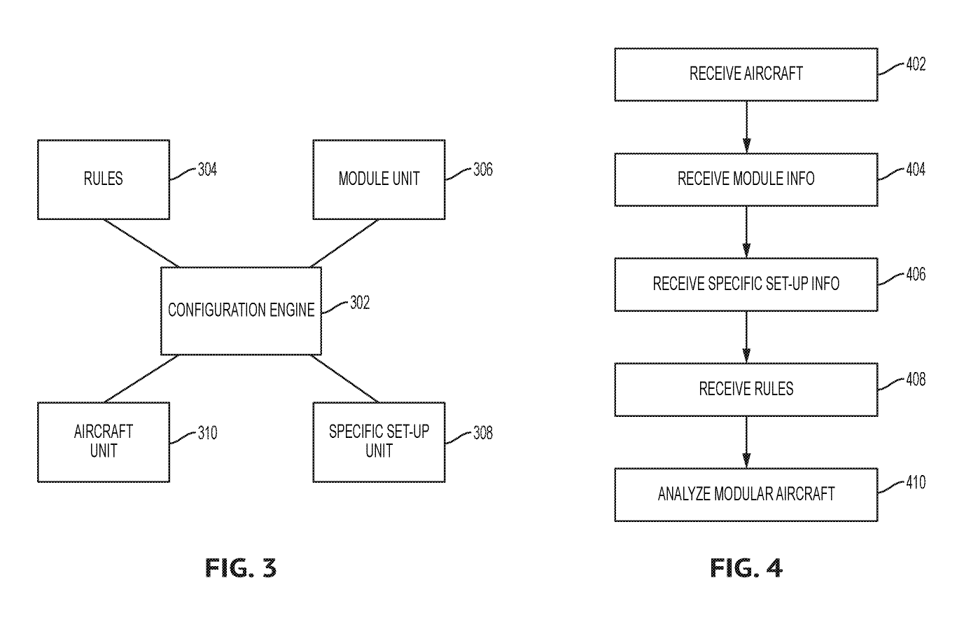

FIG. 3 shows an illustrative modular cabin design and certification system in accordance with some embodiments of the present disclosure. In an embodiment, the modular cabin design and certification system may include a configuration engine 302 and a plurality of module information (or design) units, each of the module information units providing information that may be used as factors to assist in the design and certification at a module level and of module configurations at an aircraft level. Through the module-level procedures, module designers may be provided with a smart and guided interface that assists in designing and manufacturing modules that are compatible with aircraft and certified for use in the aircraft. Through aircraft-level procedures, module installations within an aircraft and module combinations may be tested and certified. Through a result of this guided design and certification process, module designers and suppliers may create modules with confidence that they will be certified for use with aircraft, and airlines and module suppliers may ensure that particular module installations and configurations are certified for flight.

Although the modular cabin design and certification system may include any suitable components, in an embodiment the modular cabin design and certification system may include servers and computing systems and may be in communication with additional components over a network. For each module-level or aircraft-level design, the configuration engine 302 may receive information such as requirements for module dimensions, requirements for module interfaces, certification rules, design rules, aircraft compatibility rules, as well as specific design features provided by the designer. For example, in an embodiment configuration engine 302 may provide selection procedures, algorithms, and a user interface to facilitate the creation and certification of new modules and aircraft-level module configurations. In an exemplary embodiment of a configuration engine 302 for a module designer, preliminary information about acceptable options for module configuration, utilities, interfaces, and amenities may be provided to a designer, providing a framework for design of the modules. In an exemplary embodiment of a configuration engine 302 for a module designer, preliminary information about acceptable options for an aircraft level design may be provided, such limitations upon module sizes, types, amenities, and locations within a particular aircraft. These frameworks for module-level design and aircraft-level design may be utilized by operators to create and certify modules and aircraft configurations. Although input information for the configuration engine 302 may be provided by a variety of sources, in an exemplary embodiment, the input information to the configuration engine 302 may be provided by module design and certification rules 304, module information unit 306, aircraft information unit 310, and module-specific or aircraft specific setup unit 308.

The illustrative modular cabin design and certification system may include module design and certification rules unit 304. At the module level, these rules may provide design and regulatory rules for the module, such as requirements for certain utilities and services (e.g., electricity, waste processing, water storage, oxygen distribution, air distribution, etc.). The rules may also provide design rules for particular items such as installed equipment of a module, including requirements to fix certain items (e.g., chairs, tables, lounges, couches, fitness equipment, etc.) to a floor or a wall of a module, attachment requirements (e.g., fastener types, etc.) for a module, requirements for aisle size and location, height limits, etc. At the aircraft-level, rules may include requirements that certain module types must be installed within an aircraft, utilities that must be provided at different locations within an aircraft, required safety equipment, etc. Design rules for aircraft-level design may also be provided, and may include information to assist in the selection and placement of modules within an aircraft, for example, based on configurations and orderings that may have previously been certified for flight by a certification body.

The illustrative modular cabin design and certification system may also include module information unit 306. The module information unit 306 may include module design templates and rules to assist with module design. Module information may include options for placement of items (e.g., chairs, tables, pathways, window openings, etc.) within a module, options for common design items for a module that may be adjusted and/or selected (e.g., by size, design, etc.), options for lighting, options for color, options for selection of required utilities and locations of utility interfaces and connections, options for data collection devices and procedures, and other similar options that may assist in design and certification of a module. For aircraft-level design and certification, module information unit 306 may include parameters for pre-existing modules that may be placed in an aircraft, such as dimensions, utility requirements, weight, installed equipment, services provided, and safety equipment.

The illustrative modular cabin design and certification system may include aircraft information unit 310. For module-level design and certification, the aircraft information unit may have information about one or more target aircraft, such as dimensions, supported utilities, weight limitations, utility connection types, supported utility installation and locking interfaces, window and exit locations, and other similar information helpful to the installation of a particular module being designed for the target aircraft type or types. For aircraft-level design and certification, the aircraft information unit may include information such as aircraft zones that include specialized utilities, passenger entry door locations, module door locations, and other similar information that may influence or dictate the types of modules that may be used in the aircraft or locations of modules within the aircraft.

The illustrative modular cabin design and certification system may include module-specific or aircraft-specific setup unit 308. Based on the configuration engine 302 and the information from the module design and certification rules unit 304, module information unit 306, and aircraft information unit 310, a designer may be provided with options, menus, and guided interfaces to assist in the creation and/or certification of a module design and/or aircraft module installation design.

In an exemplary embodiment of module design, an exemplary designer may be provided with a framework for designing a module, which allows the designer to adjust dimensions and design features within the limitations provided by design and certification rules. The user's selections may be provided to the configuration engine 302, which may determine whether a particular design is pre-certified or provide a likelihood of certification, based on known certification histories from similar designs. In some embodiments, the configuration engine 302 may identify particular design aspects that are likely to result in design or certification issues (e.g., failure to provide proper clearance for an exit door, failure to provide sufficient storage for waste, failing to provide adequate walkways, etc.).

In an exemplary embodiment of aircraft module installation design, an exemplary designer may be provided a framework for designing a module installation for an aircraft, which allows the designer to move different modules into the aircraft, select, modify locations of modules within the aircraft, and adjust adjustable features of modules. The designer's selections may be provided to the configuration engine 302, which may determine whether a particular design is pre-certified or provide a likelihood of certification, based on known certification histories from similar designs. In some embodiments, the configuration engine 302 may identify particular design aspects that are likely to result in design or certification issues (e.g., failing to include enough restrooms, failing to provide adequate pathways to emergency exits, etc.).

FIG. 4 discloses steps for designing, certifying, selecting, distributing, and installing modules in an aircraft in accordance with some embodiments of the present disclosure. Although certain systems, hardware, software, aircraft, modules, and components may be described and depicted in certain figures, it will be understood that these methods are not limited to the specific described subject matter. Moreover, the steps depicted in FIG. 4 may be modified consistent with the present disclosure such that steps may be added and/or omitted, and that different sequencing and flow paths may be applied to FIG. 4.

FIG. 4 depicts exemplary steps for designing and certifying a modular cabin configuration in accordance with some embodiments of the present disclosure. As described herein, in an embodiment the steps of FIG. 4 may be performed by a modular cabin design and certification system utilizing hardware, software, systems, and components as described herein.

At step 402, configuration engine 302 may access aircraft information from an aircraft information unit 310. In an embodiment, the type of aircraft information that may be accessed may be based on whether the modular cabin design and certification process is being performed for a module or for a configuration of modules for an aircraft. In an embodiment, the aircraft information that may be accessed may be based on a type of aircraft (e.g., make, model, and configuration) or aircrafts that the modules are being designed for or that the modules will be installed in for a configuration. Once the aircraft information has been accessed, processing may continue to step 404.

At step 404, configuration engine 302 may access module information from a module information unit 306. In an embodiment, the type of module information that may be accessed may be based on whether the modular cabin design and certification process is being performed for a module or for a configuration of modules for an aircraft. In an embodiment, the aircraft information that may be accessed may be based on a type of module (e.g., application, utility needs, etc.) that is being designed or the types of modules that are being configured within an aircraft cabin. Once the module information has been accessed, processing may continue to step 406.

At step 406, configuration engine 302 may access specific set-up information from a module-specific or aircraft-specific setup unit 308. In an embodiment, the type of set-up information that may be accessed may be based on whether the modular cabin design and certification process is being performed for a module or for a configuration of modules for an aircraft. In an embodiment, the set-up information that may be accessed may be provided by a user based on menus and designed tools provided at a user interface. The information may provide specific design parameters for a module or for a configuration of modules within an aircraft. Once the specific set-up information has been accessed, processing may continue to step 408.

At step 408, configuration engine 302 may access design and certification rules from 304. In an embodiment, the type of design and modification rules that may be accessed may be based on whether the modular cabin design and certification process is being performed for a module or for a configuration of modules for an aircraft. In an embodiment, the design rules may be specified by an entity such as an aircraft manufacturer, airline, or module manufacturer, and may relate to design principles that result in high-quality module construction. In an embodiment, certification rules may relate to regulations and certifications that are required for the module to be approved for flight or for a configuration of modules to be approved for flight. Once the design and certification rules have been accessed, processing may continue to step 410.

At step 410, configuration engine 302 may analyze the design based on the information acquired in steps 402-408. In an embodiment, the analysis may be based on whether the modular cabin design and certification process is being performed for a module or for a configuration of modules for an aircraft. In an embodiment, the analysis may determine whether the design meets requirements (e.g., design and certification requirements), or may quantify a likelihood that the design meets requirements. In some embodiments, feedback may be provided regarding problematic portions of the design or suggested design solutions. Once the analysis has been performed, the processing of FIG. 4 may end.

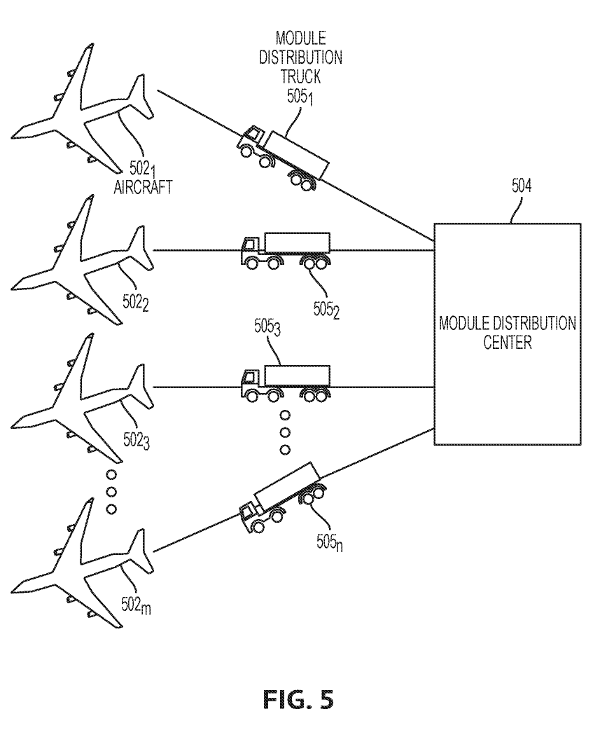

FIG. 5 shows an illustrative module distribution system of an airport in accordance with some embodiments of the present disclosure. In an embodiment, the module distribution system includes modular passenger aircraft 502₁-502ₙ, one or module distribution centers 504, and module distribution trucks 506₁-506ₘ. As described herein, modules may be distributed in a variety of manners based on different module distribution patterns and schedules. This system represents only a single embodiment and it will be appreciated that other module distribution systems may be deployed based on factors such airline preference, availability of hanger space, module distribution schedules, saturation of airlines at individual airports, and other factors.

In an embodiment, module distribution center 504 may function as a central hub for modules to be distributed to aircraft. Although module distribution center 504 is depicted and described as functioning as a single centralized location, it will be understood that a number of module distribution centers may be provided at a single airport location, e.g., for different terminals. Operations for the module distribution center 504 may be managed as a central location by an airport operational authority, by airlines, by suppliers, by other suitable entities, or combination thereof.

Module distribution center 504 may include warehousing for modules, loading docks for module distribution trucks 506₁-506ₘ, and warehousing infrastructure and equipment (e.g., automated forklifts, module racks, etc.) to facilitate efficient access to modules within the module distribution center 504. The module distribution center 504 may also include a module control center (not depicted independently) which may include servers, computers, communications equipment, and operator terminals. In some embodiments, the module control center may be located at a remote location.

In an embodiment, the module control center may receive instructions in the form of customer and airline preference data as described herein (e.g., type of aircraft number of passengers, arrival and departure time, installed modules on the aircraft, status of installed modules, services requested by passengers, destination airport, etc.). In a given flight, modules may also be selected as mandatory modules such as lavatory and safety modules. Based on this information and other information (e.g., availability of modules at the module distribution center, airline bids for modules in an auction system, etc.), the module control center may determine the desired module configuration for a given flight.

Once the module configuration for a given flight has been determined, the module control center may determine which modules need to be installed in the aircraft 502 and schedule the distribution of the modules from the module distribution center 504 to the aircraft 502. In an embodiment, modules may be accessed from storage at the module distribution center (e.g., automated mobile racks) and provided to one or more module distribution trucks 506 (e.g., using forklifts, etc.) as may be necessary to provide the desired modules to the aircraft.

The module distribution trucks 506 may accommodate one or more modules on a bed of each module distribution truck 506, and in some embodiments, a fleet of module distribution trucks may include different sized beds to efficiently accommodate different numbers of modules. The module distribution trucks 506 may include a lift system that allows the modules to be installed directly into the aircraft 502 from the module distribution truck 506.

The module distribution trucks 506 may also return used modules to the module distribution center 504 or to another building (e.g., a module cleaning and replenishment center, not depicted separately herein). In an embodiment, returns may be arranged efficiently such that a module distribution truck 506 that offloads its module to a first aircraft 502 (e.g., module distribution truck 506₁, which has delivered and installed modules at aircraft 502₁) may travel to a gate associated with an aircraft that is arriving (e.g., a gate associated with aircraft 502₂). The modules may be removed from aircraft 502₂ by module distribution truck 506₁ as a module distribution truck 506₂ including new modules for aircraft 502₂ is arriving.

In an embodiment, the used modules (e.g., used modules from aircraft 502₂ returned on module distribution truck 506₁) may be returned for cleaning and replenishment (e.g., at a module cleaning and replenishment center of module distribution center 504). At this center, the modules may be cleaned and replenished using specialized (e.g., fully or partially automated) cleaning equipment for fast, efficient, and environmentally friendly cleaning. The modules may be inspected and repaired as necessary, resources for the module may be replenished, the modules may be returned to service via the module distribution center 504.

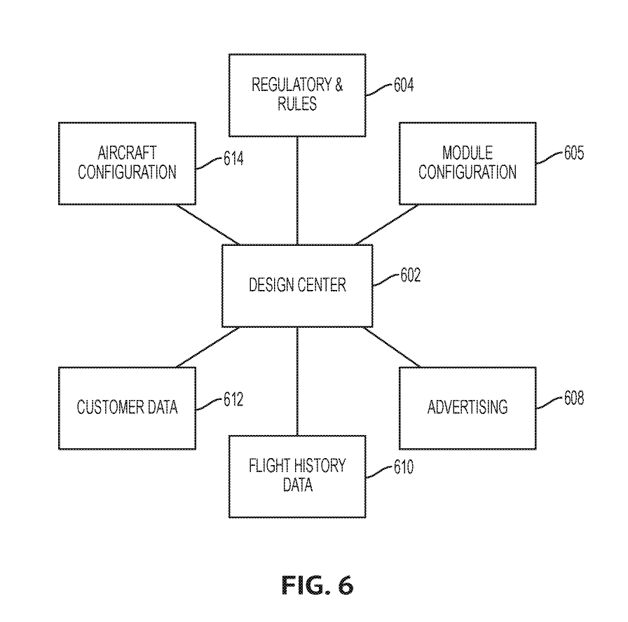

FIG. 6 shows an illustrative module selection system in accordance with some embodiments of the present disclosure. In an embodiment, the module selection system includes a module design center 602 and a plurality of module information units, each of the module information units providing information that may be used as factors to assist in the selection of modules for a particular aircraft and/or flight. Attention to these factors will ensure both that a proposed module will physically fit into an airframe and attach to services such as through a centralized utility bus 106, provides modules that are desired by customers and profitable for the airline, and further ensures that regulatory requirements such as safety, space, accommodation, and other requirements, are met with respect to each module individually. In an embodiment, the module selection system may be employed at a module control center of a module distribution center 504.

Although the module selection system may include any suitable components, in an embodiment the module selection system may include servers and computing systems and may be in communication with additional components over a network. For each flight, the module design center 602 may receive flight information such as arrival time, departure time, installed units, status of installed units, destination city and aircraft type. For example, in an embodiment a module design center 602 may provide selection procedures and algorithms and a user interface to facilitate selection of modules for flights. In an exemplary embodiment of a module design center for a particular airline operating at an airport, preliminary selections of modules may be made automatically based on the flight information and information acquired from the module information units while an operator of the module design center may confirm, modify, and update module selections. Although input information for a module design center 602 may be provided by a variety of sources, in an exemplary embodiment, the input information to the module design center 602 may be provided by regulatory and selection rules unit 604, module configuration unit 606, aircraft configuration unit 614, advertising information unit 608, flight history unit 610, and customer data unit 612.

The module selection system may include a regulatory and rules unit 604. An exemplary regulatory and rules unit may provide a set of rules as to the allowable modules, combinations of modules, and location of module installations within a particular aircraft. For example, regulatory rules may require that certain modules be installed within the aircraft or at certain locations within the aircraft. In some embodiments as described herein, only certain combinations of modules may have been certified for flight together, or for certain aircrafts, or for certain routes (e.g., based on time of flight, national laws, state laws, etc.). The regulatory and rules unit may also include a rules design and modification interface that permits operators or other users to program predesigned preferred or allowed configurations, such that selection of appropriate modules may be performed automatically based on flight information data and data received from other module information units.

The module selection system may also include an aircraft configuration unit 614. Modules created as part of the invention may be designed to fit within airframes of specified aircraft. The aircraft type and/or an aircraft identifier may be known from the flight information, and may be used to access information about an aircraft, such as approved modules, available utilities, locations of special utility zones, different module sizes permitted within the aircraft, types of connection points utilized by the common utility bus of the aircraft, other suitable information relating to aircraft type and/or a particular aircraft, and aircraft-specific information (e.g., indicating that a certain utility is temporarily unavailable at a location within the aircraft).

The module selection system may also include a module configuration unit 606. The module configuration may include information about each particular module that is available, such as the type of module, required utility hookups, module weight, module length, other module dimensions, current advertising materials installed in module, current service items installed in module (e.g., food, drinks, cosmetics, etc.), current equipment installed within a module (e.g., exercise equipment, monitors, tables, chairs, bars, etc.), module history information (e.g., usage in previous flights from the destination location), module profitability information (e.g., profitability of module from usage in previous flights from the current location to the destination location, profitability from the destination location, etc.). Module configuration unit 606 may also include information about the overall quantity and usage of modules at the module distribution center 504, for example, to determine if there is an excess inventory of certain modules at the module distribution center 504.

The module selection system may also include an advertising unit 608. For example, module selection may be informed by a third party seeking to create an advertising 608 or immersive marketing experience on an aircraft. For example, a movie studio may create a module that lets passengers interact with characters from the movie, purchase movie merchandise, or view advance screenings and/or trailers. A fitness module may be sponsored by fitness apparel companies, an office module may be sponsored by office supply companies, and a restaurant may sponsor a dining module. Portions of the cabin may also include sponsored materials such as physical advertisements, promotional materials and electronic advertisements provided with entertainment options and/or internet connectivity. In an embodiment, advertising unit 608 may also include information about advertisements that are to be provided to modules electronically, which may then be provide to the modules prior to distribution. In an embodiment, advertising unit 608 may also include information about advertiser bids for providing advertising on certain routes, for certain flight time, for customers meeting certain demographic profiles, for particular module combinations, and for other suitable information relevant to advertising value. In some embodiments, advertisements may be provided in modules, or modules including aircraft may be provided to aircraft, based on a dynamic pricing system such as an auction and bidding system. For example, an airline may provide advertisers with information about a route and time such as historical profitability as well as information relating to customer demographics and requests. Advertisers could then bid to have their sponsored modules or advertisements used in the aircraft.

The module selection system may also include flight history information 610. Such data might provide information related to use of individual modules, customer willingness to pay, and revenue generated from modules or from services offered within modules. For example, flight history information may compile information from the particular aircraft, the particular, route, and similar routes throughout the system (e.g., based on demography of passengers, flight time, etc.), based on information collected from the modules and/or the data bus of the aircraft from prior flights. This information may also include module performance metrics such as utilization, expected usage vs. actual usage, customer ratings for modules, module error rates, and other similar information.

The module selection system may also include a customer data unit 612. For example, customers in the aggregate or on a given flight may express a preference, and willingness to pay for particular services from modules. Customer preferences may be acquired in a priority of manners, for example, during the booking process, during check in, via application interfaces, and at kiosks at a gate (e.g., provided by advertisers or module sponsors). Customer preferences may be registered through voting systems, by purchasing module access, through online bidding, and through use of loyalty programs. For example, in a voting system votes may be acquired and may be weighted based on factors such as frequent flyer status, demographic information, purchasing history, and other information that may be used to determine the likelihood that a passenger will purchase module services. In an embodiment, customers may be bid on modules to be inserted, spaces within modules, and module services. In this manner, an airline may dynamically allocate the most efficient and profitable modules to an aircraft.

Once the module design center 602 has received all of the relevant information from the regulatory and selection rules unit 604, module configuration unit 606, aircraft configuration unit 614, advertising information unit 608, flight history unit 610, and customer data unit 612, it may determine the modules that are assigned to the aircraft as well as the physical ordering of modules within the aircraft. In some embodiments, a number of possible options may be provided to an operator such that the operator may select between cabin configuration modules, and in some embodiments, swipe out certain modules. In some embodiments, the information provided to the operator for module selection may include module metrics relating to usage rates, profitability, etc., that may be provided to an operator dashboard to assist in final module selection. In some embodiments, a dashboard for an operator may include information about other aircraft and/or the available modules at the module distribution center, such that the operator can observer how choices of module for a particular flight may impact other flights or the existing module inventory. Once the selection process is complete, information about the selected modules may be provided to the module distribution system to access the modules and transport the modules to the aircraft for installation.

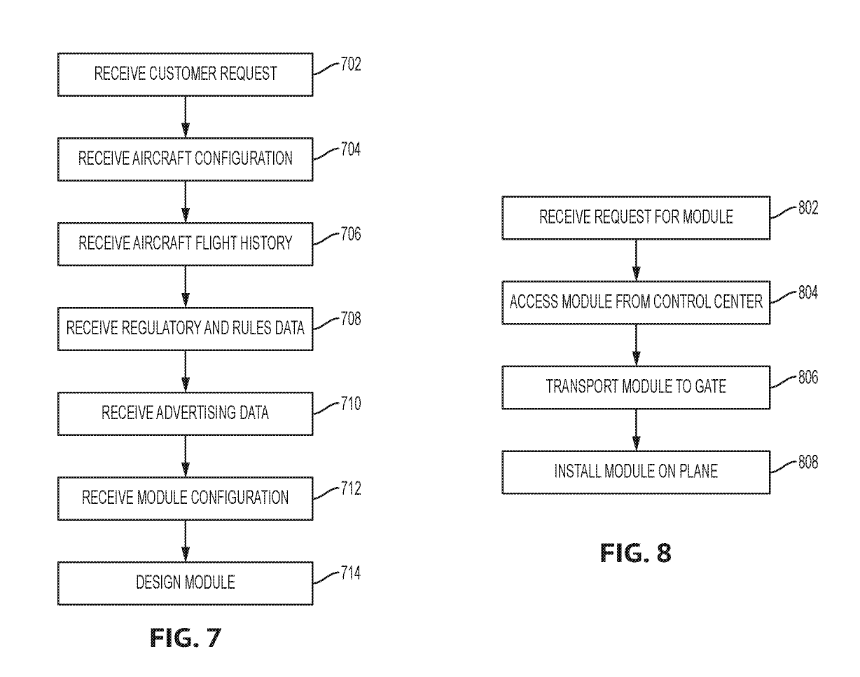

FIGS. 7-8 disclose steps for designing, certifying, selecting, distributing, and installing modules in an aircraft in accordance with some embodiments of the present disclosure. Although certain systems, hardware, software, aircraft, modules, and components may be described and depicted in FIGS. 7-8, it will be understood that these methods are not limited to the specific described subject matter. Moreover, the steps depicted in FIGS. 7-8 may be modified consistent with the present disclosure such that steps may be added and/or omitted, and that different sequencing and flow paths may be applied to FIGS. 7-8.

FIG. 7 depicts exemplary steps for designing an aircraft and module configuration in accordance with some embodiments of the present disclosure. At step 702, a module design center 602 (e.g., of a module control center) may receive a customer request, such as from a customer data unit 612 of FIG. 6. As described herein, customers in the aggregate or on a given flight may express a preference, and willingness to pay for particular services from modules. Customer preferences may be acquired in a priority of manners, for example, during the booking process, during check in, via application interfaces, and at kiosks at a gate (e.g., provided by advertisers or module sponsors). Customer preferences may be registered through voting systems, by purchasing module access, through online bidding, and through use of loyalty programs. For example, in a voting system votes may be acquired and may be weighted based on factors such as frequent flyer status, demographic information, purchasing history, and other information that may be used to determine the likelihood that a passenger will purchase module services. In an embodiment, customers may bid on modules to be inserted, spaces within modules, and module services. Once the customer information has been acquired, processing may continue to step 704.

At step 704, module design center 602 may receive an aircraft configuration, such as from an aircraft configuration unit 614 shown in FIG. 6. As described herein, modules for use in a modular passenger aircraft may be designed to fit within airframes of specified aircraft. The aircraft type and/or an aircraft identifier may be known from flight information, and may be used to access information about an aircraft, such as approved modules, available utilities, locations of special utility zones, different module sizes permitted within the aircraft, types of connection points utilized by the common utility bus of the aircraft, other suitable information relating to aircraft type and/or a particular aircraft, and aircraft-specific information (e.g., indicating that a certain utility is temporarily unavailable at a location within the aircraft). Once the aircraft information has been accessed, processing may continue to step 706.

At step 706, module design center 602 may receive aircraft flight history data, such as from a flight history unit 610 shown in FIG. 6. As described herein, such data might provide information related to use of individual modules, customer willingness to pay, and revenue generated from modules or from services offered within modules. For example, flight history information may compile information from the particular aircraft, the particular, route, and similar routes throughout the system (e.g., based on demography of passengers, flight time, etc.), based on information collected from the modules and/or the data bus of the aircraft from prior flights. This information may also include module performance metrics such as utilization, expected usage vs. actual usage, customer ratings for modules, module error rates, and other similar information. Processing may then continue to step 708.

At step 708, module design center 602 may receive regulatory and rules data, such as from a regulatory and rules unit 604 shown in FIG. 6. For example, regulatory and rules data may include a set of rules as to the allowable modules, combinations of modules, and location of module installations within a particular aircraft. As describe herein, regulatory rules may require that certain modules be installed within the aircraft or at certain locations within the aircraft. In some embodiments as described herein, only certain combinations of modules may have been certified for flight together, or for certain aircrafts, or for certain routes (e.g., based on time of flight, national laws, state laws, etc.). The regulatory and rules data may also include a rules design and modification interface that permits operators or other users to program predesigned preferred or allowed configurations, such that selection of appropriate modules may be performed automatically based on flight information data and data received from other module information units. Once the regulatory and rules data has been acquired, processing may continue to step 710.

At step 710, module design center 602 may receive advertising data, such as from an advertising information unit 608 shown in FIG. 6. For example, module selection may be informed by a third party seeking to create an advertising 608 or immersive marketing experience on an aircraft. For example, as described herein, a movie studio may create a module that lets passengers interact with characters from the movie, purchase movie merchandise, or view advance screenings and/or trailers. A fitness module may be sponsored by fitness apparel companies, an office module may be sponsored by office supply companies, and a restaurant may sponsor a dining module. Portions of the cabin may also include sponsored materials such as physical advertisements, promotional materials and electronic advertisements provided with entertainment options and/or internet connectivity. In an embodiment, advertising unit 608 may also include information about advertisements that are to be provided to modules electronically, which may then be provide to the modules prior to distribution. In an embodiment, advertising unit 608 may also include information about advertiser bids for providing advertising on certain routes, for certain flight time, for customers meeting certain demographic profiles, for particular module combinations, and for other suitable information relevant to advertising value. In some embodiments, advertisements may be provided in modules, or modules including aircraft may be provided to aircraft, based on a dynamic pricing system such as an auction and bidding system. For example, an airline may provide advertisers with information about a route and time such as historical profitability as well as information relating to customer demographics and requests. Advertisers could then bid to have their sponsored modules or advertisements used in the aircraft. Once the advertising information has been obtained, processing may continue to step 712.

At step 712, module design center 602 may receive a module configuration, such as form a module configuration unit 606 shown in FIG. 6. As described herein, a module configuration may include information about each particular module that is available, such as the type of module, required utility hookups, module weight, module length, other module dimensions, current advertising materials installed in module, current service items installed in module (e.g., food, drinks, cosmetics, etc.), current equipment installed within a module (e.g., exercise equipment, monitors, tables, chairs, bars, etc.), module history information (e.g., usage in previous flights from the destination location), module profitability information (e.g., profitability of module from usage in previous flights from the current location to the destination location, profitability from the destination location, etc.). The module configuration may also include information about the overall quantity and usage of modules at the module distribution center 504, for example, to determine if there is an excess inventory of certain modules at the module distribution center 504. Once the module information has been accessed, processing may continue to step 714.

At step 714, a module design center, such as a module design center 602 shown in FIG. 6, may determine the modules that are assigned to the aircraft as well as the physical ordering of modules within the aircraft. As describe herein, in some embodiments, a number of possible options may be provided to an operator such that the operator may select between cabin configuration modules, and in some embodiments, swipe out certain modules. In some embodiments, the information provided to the operator for module selection may include module metrics relating to usage rates, profitability, etc., that may be provided to an operator dashboard to assist in final module selection. In some embodiments, a dashboard for an operator may include information about other aircraft and/or the available modules at the module distribution center, such that the operator can observer how choices of module for a particular flight may impact other flights or the existing module inventory. Once the selection process is complete, information about the selected modules may be provided to the module distribution system to access the modules and transport the modules to the aircraft for installation.

FIG. 8 depicts exemplary steps for assembling a modular cabin of an aircraft in accordance with some embodiments of the present disclosure. In an embodiment, the steps may be performed by components of a module distribution system such as is described herein.

At step 802, a module control center may receive a request for a module. As described herein, an aircraft may require one or more modules to be changed (e.g., an aircraft may be landing and may need to replace some modules). As described with respect to FIGS. 5-7 herein, information may be provided to the module control center that may allow a decision to be made regarding modules to be installed in the aircraft. Once the modules to be installed have been determined, processing may continue to step 804.

At step 804, a module is accessed which conforms to the components of the received module request. As described herein, in an embodiment, the module may be accessed from storage at the module distribution center (e.g., from an inventory of available modules) and provided to a module distribution truck such as a module distribution truck 306 (e.g., at loading docks). Once the modules have been accessed from the distribution center, processing may continue to step 806.

At step 806, the accessed modules may be transported to the gate where the associated aircraft is located, as described herein (e.g., by the module distribution trucks). Once the modules have been transported to the aircraft, processing may continue to step 808.

At step 808, the modules may be installed on an aircraft. As described herein, the module distribution truck may include a lift system that allows the module to be installed directly an aircraft from the module distribution truck. The modules may then be inserted into the aircraft, positioned in the correct portion of the aircraft, locked into place, and attached to utilities. Once the modules have been installed, the processing of FIG. 8 may end.

The examples and embodiments provided herein are provided for illustrative purposes and are not intended to limit the application or claims provided herein. It will be understood that the specific embodiments disclosed herein and the systems, components, methods, modules, aircraft, etc. described herein need not take the specific form described, but may instead be applied in various different or additional manners consistent with the present disclosure and claims. It will further be understood that the present disclosure need not take the specific form explicitly described herein, and the present disclosure is intended to include changes variations thereof, consistent with the appended claims and the present disclosure, for example, to optimize the subject matter described herein. The disclosed subject matter is not limited to any single or specific embodiment described herein, but rather should be construed in breadth and scope in accordance with the appended claims.

1. A method, comprising:
receiving flight information;
receiving module configuration information; and
determining one or more modules to provide to an aircraft based on the flight information and the module configuration information.

2. The method of claim 1, wherein the module configuration information comprises one or more of selection rules, aircraft configuration information, and user-specified information.

3. The method of claim 1, wherein the module configuration information comprises selection rules, the selection rules comprising module-level configuration rules.

4. The method of claim 3, wherein the module-level configuration rules comprise one or more of utility requirements, regulatory requirements, fixed item standards, attachment requirements, aisle requirements, or height limits.

5. The method of claim 1, wherein the module configuration information comprises selection rules, the selection rules comprising aircraft-level configuration rules.

6-26. (canceled)

27. A passenger module of an aircraft, comprising:
an enclosure;
one or more locking mechanisms located fixedly attached to the enclosure, wherein the one or more locking mechanisms are configured to fixedly locate the passenger module relative to corresponding mechanisms of a modular aircraft cabin;
one or more connection devices fixedly attached to the enclosure, wherein the one or more connection devices are configured to attach to corresponding utility connections of the modular aircraft cabin;
one or more module features located within the interior of the enclosure.

28. The passenger module of claim 27, wherein a shape defined by an exterior surface of the enclosure substantially conforms to a module cargo area of the modular aircraft cabin.

29. The passenger module of claim 27, further comprising one or more insertion features fixedly attached to the enclosure, wherein the insertion features facilitate movement of the passenger module within the module cargo area of the modular aircraft cabin.

30. The passenger module of claim 29, wherein the one or more insertion features are located at least at a bottom exterior surface of the enclosure.

31. The passenger module of claim 29, wherein the one or more insertion features comprise one or more of rollers, tracks, pulleys, drive systems, or hooks.

32-56. (canceled)

57. An aircraft, comprising:
an airframe having an exterior surface;
a plurality of modules, each of the plurality of modules having a plurality of walls, a floor and an interior volume, wherein the plurality of modules form a modular cabin interior when positioned within the exterior surface of the airframe;
a plurality of locking mechanisms that lock the plurality of modules to the airframe; and
a plurality of connection points that connect an aircraft utility to the plurality of modules.

58. The aircraft of claim 57, wherein the utility is electricity.

59. The aircraft of claim 57, further comprising a module door, wherein each of the plurality of modules is insertable into the airframe through the module door.

60. The aircraft of claim 59, wherein each of the plurality of modules are adapted to be movable between positions within the exterior surface after insertion through the module door.

61. The aircraft of claim 57, wherein each of the plurality of modules is positioned in sequence along a length of the aircraft.

62-65. (canceled)

66. A method of configuring a modular cabin interior of an aircraft, comprising:
inserting a first module through a module door of the aircraft such that the first module is within an exterior surface of the aircraft, wherein the first module comprises a floor, a plurality of walls, and an interior volume;
moving the first module to a first position within the aircraft;
locking the first module to the aircraft.

67. The method of claim 66, wherein the first module comprises passenger seating within the interior volume.

68. The method of claim 67, further comprising connecting an aircraft utility bus to the first module.

69. The method of claim 66, further comprising:
inserting a second module through the module door of the aircraft such that the second module is within the exterior surface of the aircraft, wherein the second module comprises a floor, a plurality of walls, and an interior volume;
moving the second module to a second position within the aircraft;
locking the second module to the aircraft.

70. The method of claim 69, further comprising:
transporting the first module to the aircraft while the aircraft is at the gate prior to inserting the first module through the module door.

71-73. (canceled)
